(19) United States
(12) Patent Application Publication
(10) Pub. No.: US 2016/0321746 A1
(43) Pub. Date: Nov. 3, 2016

(54) TRADING SYSTEM AND METHOD WITH USER-DEFINED INSTALLMENTS

(71) Applicant: INSTALLMENTS INC., GRAND CAYMAN KY1-1002 (KY)

(72) Inventor: JEN-BING CHEN, GRAND CAYMAN KY1-1002 (KY)

(21) Appl. No.: 15/142,535

(22) Filed: Apr. 29, 2016

(30) Foreign Application Priority Data
Apr. 30, 2015 (TW) 104113836

(51) Int. Cl. G06Q 40/02; G06Q 40/04

(52) U.S. Cl. CPC G06Q 40/025; G06Q 40/04

(57) ABSTRACT

A trading method with user-defined installments is provided. A seller transmits a commodity data and an installment data to a server, and a buyer transmits a buyer credit data and an order data to the server. The server matches the data transmitted by the seller and the buyer, and then transmits a trading agreement respectively to the seller and the buyer. Thus, the seller will realize the installment data selected by the buyer, and the buyer is able to pay by installment according to the trading agreement.

### BACKGROUND

1. Technical Field

The present invention relates to a trading system and method with user-defined installments, and particularly relates to a system and method that could let the seller defined the number of the payments and the buyer could select suitable installment plan to pay.

2. Related Art

As the computer technology develops, human's life has changed and lots of convenient has brought in to our life. With the flourishing of the e-business, many commodity or service could be transacted through electronic trading platform. Electronic commerce or e-business is related to a business or seller that provides rapid and effective trading through a virtual platform. The business customer or general consumer could purchase commodity or other services through these trading platforms.

The electronic transaction gradually has spread between individuals, such as consumer-to-consumer (C2C) type e-commerce. Generally, these transactions are conducted through a third party, which provides the online platform where the transactions are actually carried out. The online platform could be platform such as amazon, marketplace, e-bay or the like.

The seller will upload the commodity and the service content to the online platform that the third party provided. The potential buyer could view and click the commodity or the service on the online platform, and select the paying means and shipping method. The paying means could be pay in full or pay in installments, in other way of speaking the paying plan are fixed and unchangeable.

Furthermore, the paying means of nowadays installment is held by a third party service provider. The third party service provider will represent both side of the transaction to assign an agreement similar to loan agreement with a third party financial institution.

The third party financial institution will pay the total amount to the seller and collect monthly payment, interest or service charge from the buyer.

Although paying through the installment is widely accepted, the extract interest or service charge for the third party financial institution will increase the commodity price. Even if the seller agrees the buyer to pay by installment, the seller could not gain extract profit from this paying agreement.

### DISCLOSURE OF THE INVENTION

Present invention provides a trading system and method that user could self-define installment. The system and method could be applied at a C2C electronic transaction platform. In this trading system and method, seller could define multiple different numbers of payments for buyer to select from while purchasing goods, services or real estate having a cost. The server will pass the trading agreement to the seller and the buyer after receiving the order data from the buyer. Then the buyer's payment will be paid according to the installment agreement. Furthermore, the service fee of each payment will be pay directly to the seller rather than third party financial institution. Thus, the seller could gain extra profits. The seller could also share portion of the profit with the buyer, and creates a win-win situation by eliminate the service charge from the third party financial institution.

Present invention provides a trading system and method that user could self-define installment. The system and method could be applied at a C2C electronic transaction platform. At the first time of the buyer or the seller transmit the credit data to the server, the server will save and verify the reliability and accuracy of the credit date in order to secure the equity of both side and reduce the risk of the transaction.

According to a first embodiment of the present invention, the system comprises at least one first electrical device, at least one second electrical device and a server. The at least one first electrical device provides a commodity data and an installment data. The at least one second electrical device provides a buyer credit data and an order data. The server will receives the commodity data and the installment data from the first electrical device and the buyer credit data from the second electrical device.

In addition, the second electrical device transmits the buyer credit data and an order data to the server, and then the server matches the order data of the second electrical device with the commodity data and the installment data from the first electrical device. A trading agreement will be transmitted to the first and the second electrical devices.

According to one embodiment, wherein the buyer credit data comprises address, email address, telephone number, social network account, identification card number, banking account number, income data, deposit card number, credit card number, debit card number, account number of third party payment service, credit score or credit rating.

According to one embodiment, wherein the installment data comprises the number of payments, amount of the installment, down payment or service charge.

According to one embodiment, wherein the trading agreement is a legal binding document.

According to one embodiment, wherein the first electrical device transmits a credit rating request to the server, and the server compares the credit rating request with the buyer credit data.

According to one embodiment, wherein the first electrical device transmits a seller credit data to the server.

According to one embodiment, wherein the seller credit data comprises address, email address, telephone number, social network account, identification card number, banking account number, income data, credit score or credit rating.

According to one embodiment, wherein the first electrical device encrypts the commodity data, the installment data and the seller credit data. The second electrical device encrypts the seller credit data.

In other embodiment, a trading method with user-defined installments is provided.

The system comprises the following steps. First, the server receives at least one commodity data and at least one installment data from the seller. Then, the server receives at least one buyer credit data and at least one order data from the buyer. The server matches the commodity data and the installment data from the seller with order data from the buyer. The server transmits a trading agreement respectively to the seller and the buyer.

According to one embodiment, further comprises: the server verifying the buyer credit data that provided by the buyer.

According to one embodiment, further comprises: the seller transmitting the seller credit data to the server.

According to one embodiment, wherein the server receives a credit rating request from the seller and the server compares the credit rating request with the buyer credit data.

According to one embodiment, wherein a first electrical device encrypts the commodity data, the installment data and the seller credit data. The second electrical device encrypts the seller credit data.

According to one embodiment, wherein the trading agreement comprises a term while if any one of the installments is failed to pay or not fully paid after the due date, a third party will provide an installment load to cover up the installment in order to continue the trade.

In another embodiment, the server connectable to a communication network for providing a service that provides a user-defined installments service, the server comprising an input, a matching unit and an output. The input could receive at least one commodity data and at least one installment data from a first electrical device, and at least one buyer credit data and at least one order data from a second electrical device. The matching unit matches the commodity data and the installment data with order data. The output transmits a trading agreement respectively to the first electrical device and the second electrical device.

According to one embodiment, the server further comprises a verifying unit for verifying the buyer credit data.

According to one embodiment, wherein the input receiving the seller credit data from the first electrical device.

According to one embodiment, wherein the server receives a credit rating request from the first electrical device and the server compares the credit rating request with the buyer credit data.

According to one embodiment, wherein the trading agreement comprises a term while if any one of the installments is failed to pay or not fully paid after the due date, a third party will provide an installment load to cover up the installment in order to continue the trade.

### BRIEF DESCRIPTION OF THE DRAWINGS

FIG. 1 illustrates an embodiment of block diagram of a trading system with user-defined installments;

FIG. 2 illustrates another embodiment of flow chart of a trading method with user-defined installments; and

FIGS. 3-8 illustrate an embodiment of present invention that applied as an app on mobile phone.

### DETAILED DESCRIPTION

The term “couple” and “connect” are intended to mean either an indirect or direct electrical connection in the specification. In other words, the wording of “a first device is coupled to a second device.” disclosed in the specification or the claims section means that the first device is directly electrically connected to the second device, or the first device is indirectly electrically connected to the second device via some other means or devices.

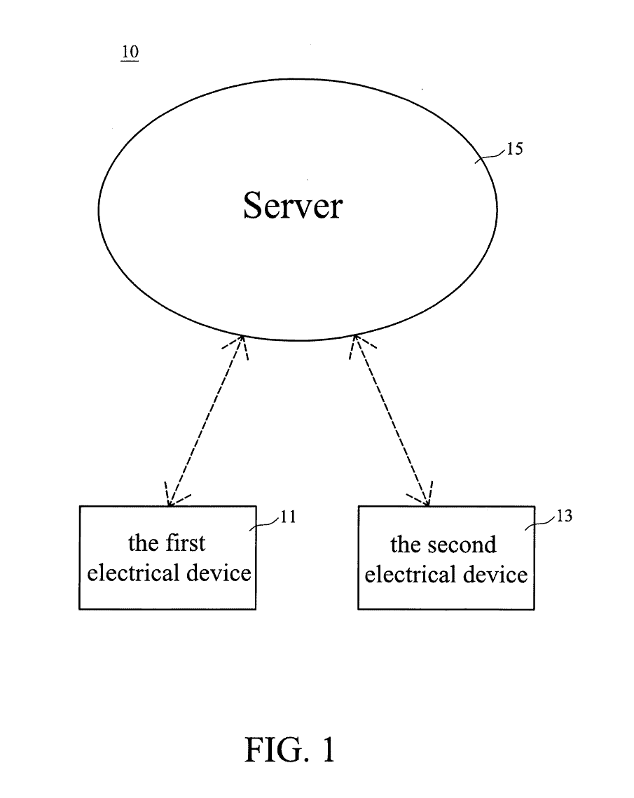

Referring to FIG. 1, FIG. 1 illustrates an embodiment of block diagram of a trading system with user-defined installments. As shown in the figure, the trading system 10 of present invention could be applied at C2C electronic transaction platform. The trading system 10 includes at least one first electrical device 11, at least one second electrical device 13 and a server 15.

In the discussion that follows, the first electrical device and second electrical device could include a display and a touch-sensitive surface is described. It should be understood, however, that the first electrical device and second electrical device may include one or more other physical user-interface devices, such as a physical keyboard, a mouse and/or a joystick.

The first electrical device 11 and the second electrical device 13 could directly or indirectly connect or couple with the server 15, thus the first electrical device 11 and the second electrical device 13 could transmit data with the server 15. For instance the first electrical device 11 and the second electrical device 13 could connect with the server 15 via internet, thus the data could transmit through internet.

The transmission may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS)), or any other suitable communication protocol, including communication protocols not yet developed as of the filing date of this document.

The first electrical device 11 and the second electrical device 13 hereinafter correspond to computing devices such as computing devices such as desktops, laptops, tablets or handhelds, including personal digital assistants (PDAs), digital music and/or video players, wearable device and mobile telephones. The user (could be buyer or seller) could review or browse the data from the server 15 by the first electrical device 11 or the second electrical device 13. Furthermore, the data could be entered and be inputted by the first electrical device 11 or the second electrical device 13 and the data could be transmitted to the server 15. These data inputted by the user or transmitted by the server 15 could be stored in the first electrical device 11 or the second electrical device 13.

In one of the embodiment of the present invention, the first electrical device 11 could be held or operated by seller. For instance the seller could operate or control the first electrical device 11 and generates the commodity data and the installment data. The commodity data and the installment data would be transmitted by the first electrical device 11 to the server 15.

The at least one first electrical device 11 provides a commodity data and an installment data. The at least one second electrical device 13 provides a buyer credit data and an order data. The server 15 will receives the commodity data and the installment data from the first electrical device 11 and the buyer credit data and the order data from the second electrical device 13.

It should be noted that the buyer credit data and an order data are not limited to provide at the same time. In some embodiment, the buyer credit could be provided once being request. Similarly, the commodity data and the installment data also are not limited to be provided at the same time.

The installment data could be the number of the payment, amount of the installment, down payment or service charge. The commodity data could be name of the commodity, the photo of the commodity, the description of the commodity or the price of the commodity. In practice, the first electrical device 11 could transmit multiple commodity data and installment data to the server 15.

The server 15 could receive and store the commodity data and the installment data transmitted by the first electrical device 11. The server 15 could be an electronic transaction platform, and the commodity data and the installment data will be shown on the electronic transaction platform. Thus, the potential buyer could view and search the commodity or service that provide on the platform via the second electrical device 13. When any of the goods, services or real estate and/or installment data arouses buyer's interest, he or she could continue the transaction on the platform.

In this embodiment, the server 15 is connectable to a communication network for providing a service that provides a user-defined installments service. Furthermore, the server 15 comprises an input, a matching unit and an output (not shown in the figures).

The input is used for receiving data; more precisely the input could receive at least one commodity data and at least one installment data from a first electrical device, and at least one buyer credit data and at least one order data from a second electrical device. The matching unit is used for matching the data from the first and the second electrical device. More precisely, the matching unit of the server 15 could match the commodity data and the installment data with order data. The output transmits a trading agreement respectively to the first electrical device and the second electrical device.

At first, the seller could input the seller credit data on the first electrical device 11 and the seller credit will be transmitted to the server 15 by the first electrical device 11. The server could receive the seller credit via the input from the first electrical device. The seller credit data could be but not limit to address, email address, telephone number, social network account, identification card number, banking account number, income data, deposit data, credit score or credit rating . . . etc. After the seller credit data transmitted to the server 15, a unique seller account ID and password will be generated automatically or manually. The seller account ID could be selected from one of the following data, such as email address, telephone number, social network account or identification card number. Afterward, the seller could use the seller account ID and the password to load in the electronic transaction platform to modify or update the commodity data and the installment data. Or the seller could transmit the modified data or the updated data via the first electrical device 11 to the server 15, and replaced the commodity data and the installment data.

In one of the embodiment of the present invention, the second electrical device 13 could be held by buyer. At first, the buyer could generate a buyer credit data by the second electrical device 13, and the buyer credit data that input or generate by the second electrical device 13 will be transmitted by the second electrical device 13 to the server 15 and being saved. The buyer credit data will be used to verify or guarantee the credit of the buyer. The buyer credit data includes but not limit to address, email address, telephone number, social network account, identification card number, banking account number, income data, deposit card number, credit card number, debit card number, account number of third party payment service, credit score or credit rating.

The server 15 could receive and store the buyer credit data transmitted by the second electrical device 13. More precisely; the input of the server could receive and store these data. The server 15 could also verify the seller credit data and/or the buyer credit data in order to decrease the risk of the following transaction. The server could further comprise a verifying unit for verifying the buyer credit data. The verifying unit also could verify the seller credit date. Therefore, the verification will be proceeding by the verifying unit of the server. For example, the server 15 could preliminary examine the accuracy of the seller credit data and/or the buyer credit data, or sending requests to the bank or corresponding agency for further verification for the seller credit data and/or the buyer credit data.

After the buyer credit data transmitted to the server 15, a unique buyer account ID and password will be generated automatically or manually. The buyer account ID could be selected from one of the above data, such as email address, telephone number, social network account or identification card number. Afterward, the buyer could use the buyer account ID and the password to accomplish load in the platform.

In practice, the seller could view the commodity data and installment data on the server 15 via a second electrical device 13. When the buyer proceed purchasing the commodity on the server 15, there will be no need to re-enter the buyer credit date, but only need to enter the buyer account ID and the password to continue the purchase. In addition, when the seller credit data provides by the seller includes the address, the address or the location of the seller could be shown on the guiding app, locating app or map app of the second electrical device 13.

After the seller confirmed to purchase the commodity, the second electrical device 13 will transmit an order data to the server 15. The order data includes the commodity data and the installment date which might include the plan of the installment the buyer selected. For instance, the seller could provide different plans with different number of payments; the buyer could select one plan according to one's need. In practice, the plans provided by the seller could be verity in number of payments, amount of the installment, down payment or service charge.

After receiving the order data from the second electrical device 13, the server 15 matches the order data with the commodity data and the installment data from the first electrical device 11 (via the matching unit of server). A trading agreement will be transmitted to the first electrical device 11 and the second electrical device 13.

The seller could receive the trading agreement via the first electrical device 11 from the server 15 in order to confirm the purchased and the details of the installment data that buyer selected. On the other side, the buyer could receive the trading agreement via the second electrical device 13 and proceed paying according to the selected paying plan, such as paying by the credit card, web banking, or atm.

In one of the embodiment of the present invention, after both sides received the trading agreement, there will be an additional confirmation step for both sides to re-agree on the content of the trading agreement. Such as when there are flaws in the trading agreement, either side could deny or close the transaction. Or when the amount of the commodity is not sufficient, the transaction could be closed too. The purchase will be preceded only if the additional confirmation is made.

The trading agreement providing by the server 15 is a legal binding transaction agreement document, which includes the installment data and the agreement between two sides. Further, the server 15 could also provide basic insurance for both sides of transaction, or addition insurance for the installment to decrease the potential lost during the trading.

The paying method could be categorized into online paying mode and offline paying mode. In the online paying mode, the seller could receive the remittance information of the seller from the server 15 via the second electrical device 13. Or the server 15 could email or text the remittance information to the second electrical device 13.

The buyer could proceed the paying according to the remittance information. As for the offline paying mode, the server 15 will generate a hyperlink of the paying website of the seller, such as URL shortcut or QR code. The buyer could click or scan the hyperlink and proceed the paying on the paying web site of the seller.

According to further embodiments, partial payment (installments) may be received from the buyer using direct transfer from the bank account or any other account of the buyer; by using a check(s), or drafts, drawn against the purchaser's bank account or any other account; by any debit card; by any credit card; by any financial instrument; by cash;

by wire transfer; by token(s) or electronic payment of tokens; by electronic payment(s) (including over the Internet); and/or by any other method(s) known today or to be devised in the future.

In some embodiments of the present invention, the seller could transmit a credit rating request to the server 15, and the server 15 compares the credit rating request sent by the first electrical device 11 with the buyer credit data from the second electrical device 13. Only if the buyer credit data provided by the second electrical device 13 matches the credit rating request from the first electrical device 11, the transaction could continue (the buyer could continue the purchase). For example, the credit rating request could include address, email address, telephone number, social network account, identification card number, banking account number, income data, deposit data, credit score or credit rating . . . etc. If the seller sets the credit rating request should include telephone number and identification card number, but these information are not included in the buyer credit data, then the transaction could not continue. The matching will be held by the server 15, so the buyer credit data will not be transmitted to the seller to avoid accidentally personal information leak.

Since the commodity data, the installment data, the credit score, the credit data of the buyer are considered as the confidential information, these information will be encrypted before the first electrical device 11 transmitting to the server 15. Similarly, the credit data of the seller will be encrypted before transmitting, too.

In one of the embodiment of the present invention, the server 15 could be an electronic transaction platform, such as C2C electronic transaction platform. Both sides of the transaction could transact via bidding. Such as, other than the number of the payments, the seller could also defines the upset price of the commodity, the bid increment of the bidding and the closing time of the auction. Therefore, the potential buyer could view the commodity or the service on the electronic transaction platform for further information.

For the clarity purpose, in the present invention only shows one first electrical device 11, one second electrical device 13 and one server 15. One in this field might realize that in reasonable use and practice, the first electrical device 11, the second electrical device 13 and the server 15 could be multiple.

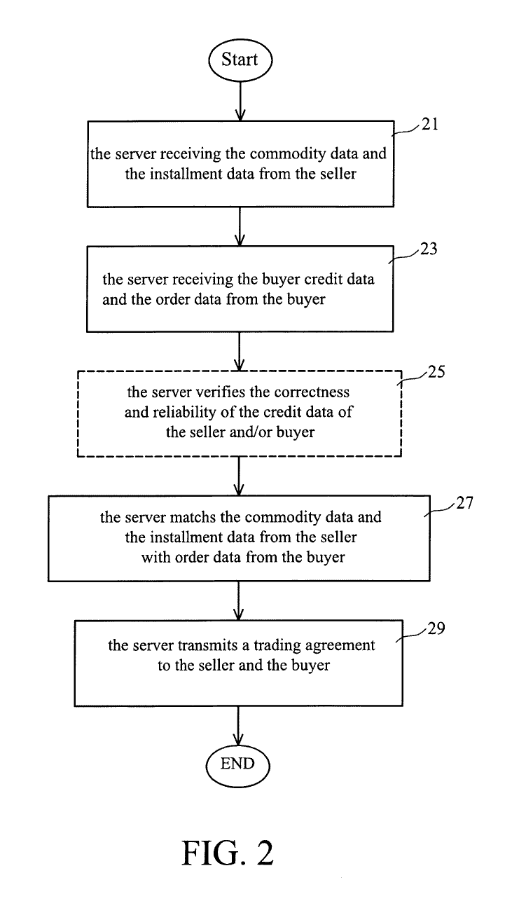

Referring to FIG. 2 and FIG. 1, FIG. 2 illustrates another embodiment of flow chart of a trading method with user-defined installments. The trading method includes a seller, a buyer and a server 15. The seller could connect with the server 15 via a first electrical device 11, and the seller could connect with the server 15 via a second electrical device 13.

The server 15 could receive at least one commodity data and at least one installment from the at least one seller as shown in step 21. For example, each of the plans will be verity in number of payment, amount of the installment, down payment or service charge. The commodity data could be name of the commodity, the photo of the commodity, the description of the commodity or the price of the commodity. The server 15 could store and receive the commodity data and the installment data, and the server 15 could be an electronic transaction platform and the commodity data and the installment data could be shown on the platform.

At first, the seller could transmit the seller credit to the server 15 by the first electrical device 11. The seller credit data could be but not limit to address, email address, telephone number, social network account, identification card number, banking account number, income data, deposit data, credit score or credit rating . . . etc. After the seller credit data transmitted to the server 15, a unique seller account ID and password will be generated automatically or manually. Afterward, the seller could use the seller account ID and the password to load in the electronic transaction platform for checking or modifying the commodity data and the installment data. Or the seller could transmit the modified data via the first electrical device 11 to the server 15 to modify the commodity data and the installment data.

Similarly, a unique buyer account ID and password will be generated automatically or manually while the buyer transmits the seller credit data to the server 15. The server 15 will receive and store the buyer credit data. The buyer credit data stands for the credit condition of the buyer. The buyer account ID could be selected from one of the below data, such as email address, telephone number, social network account or identification card number. Afterward, the buyer could use the buyer account ID and the password to accomplish load in. While the buyer decide to purchase an exact commodity shown by the server 15, the first electrical device 11 could transmit an order data to the server 15, and the order data will include the plan of payment that buyer selected (installment data) and the commodity data (shown as step 23).

In one of the embodiment of the present invention, single commodity data could include different plans with different number of payment. For example, each of the plans will be verity in number of payments, amount of the installment, down payment or service charge. The buyer could select a suitable plan according to need. The order data that transmitted to the server 15 by the seller also include the decision or the select paying plan's detail to the server 15.

In one embodiment of the present invention, after the server 15 receives the buyer credit data and/or the seller credit date, the server 15 could verify the correctness and reliability of these data. For example, the server 15 could request the credit condition of the buyer from the bank according to the buyer credit data in order to verify if the commodity is affordable for the buyer, and decrease the risk of the transaction (shown in step 25).

In one embodiment of the present invention, the seller could transmit a credit rating request to the server 15, and the server 15 compares the credit rating request sent by the seller with the buyer credit data from the buyer in order to determine whether the buyer credit data meets the credit rating request.

After receiving the order data from the buyer, the server 15 matches the order data with the commodity data and the installment data from the seller (as shown in step 27). For instance, the server 15 could compare the commodity data and the installment data that selected from the buyer with the commodity data and the installment data provided by the seller to insure the correctness of the order.

After matching, the server 15 will transmit the trading agreement to the seller and the buyer (shown in step 29.) The trading agreement providing by the server 15 is a legal binding transaction agreement document, which includes the installment data and the agreement content agreed by the both sides.

Since the commodity data, the installment data, the credit score, the credit data of the seller and the buyer are considered as the confidential information, these data will be encrypted before transmitting.

While in some embodiments, the trading agreement comprises a term while if any one of the installments is failed to pay or not fully paid after the due date, a third party will provide an installment load to cover up the installment in order to continue the trade. In this way, the buyer could avoid the fine of delaying and the seller could get each installment on time.

For instance, the seller and the buyer had agreed to pay in six installments. Then the buyer successfully paid the first two installments but fail to pay for the third installment. Once the paying due date for the payment reach, the third party i.e., bank or the above mentioned online platform will pay the third installment (the third party will automatically loan the exact third installment to the buyer.)

In different circumstances, the third party could treats each installments as separate incidents, that is, the dynamic loaning mechanism will only trigger once the due date of the installment is reached. Or, the dynamic loaning mechanism could also be set that once the due date of installment is reached, the third party or the online platform will carry on the remaining installment unless the buyer require not to.

In the trading agreement the dynamic loaning clause is one of the options for user to choose from. In some condition, the system could allow some of the buyer that has relative good credit record to automatically apply dynamic loaning. The

In this trading system and method of the present invention, the seller and the buyer could connect with the server via electrical devices, and directly select desired commodity and desired way of paying. During the interaction of paying to the seller, there will be no third party involved, therefore could cut down or eliminate the charge of the third party.

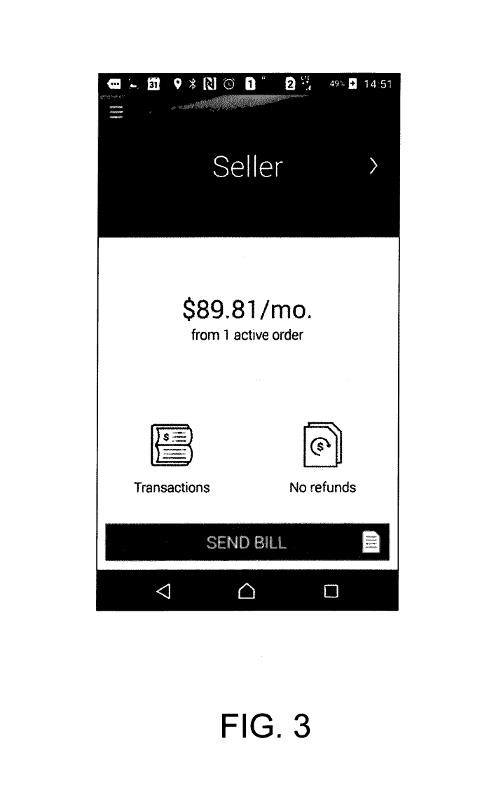

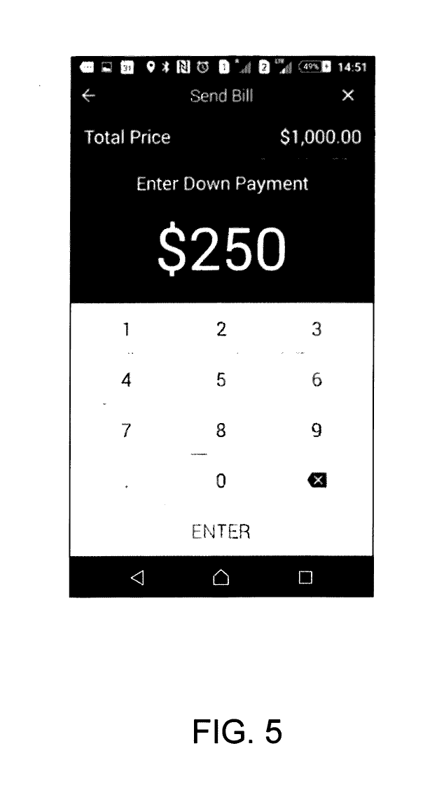

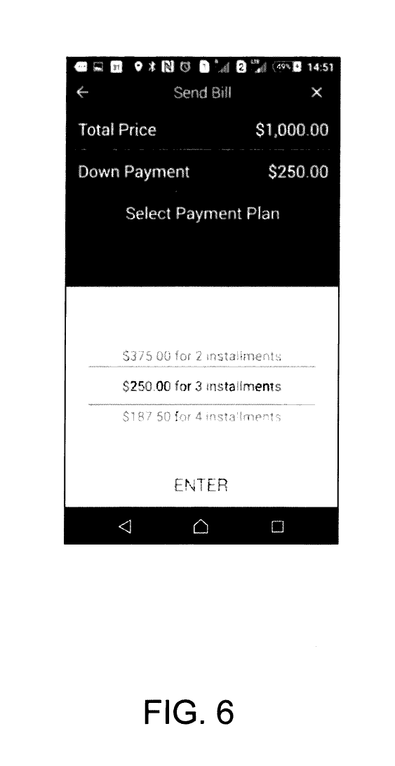

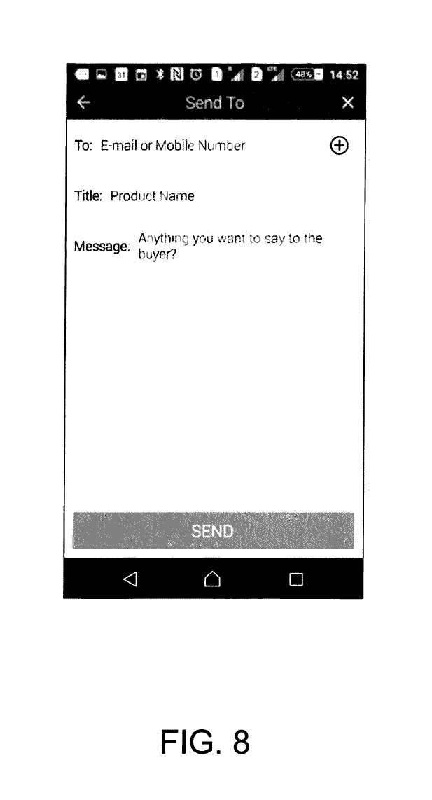

Last but not least, FIGS. 3-10 illustrate an embodiment present invention that applied as an app on mobile phone.

FIG. 3 shows an app interface, more particularly the interface on the seller side. At first, the user could create a new account and password, and once the user information is verify and/or record, the user could start sell the goods, service or the like via this platform. Once the seller loaded in the account, the seller could check the amount of the sales per month or the sales per year, the transactions and refunds. Furthermore, the seller could also send the installment data by simply clicking the icon.

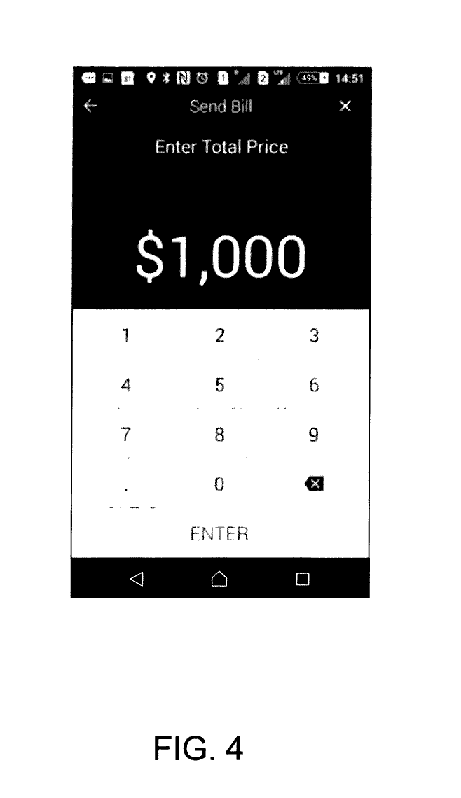

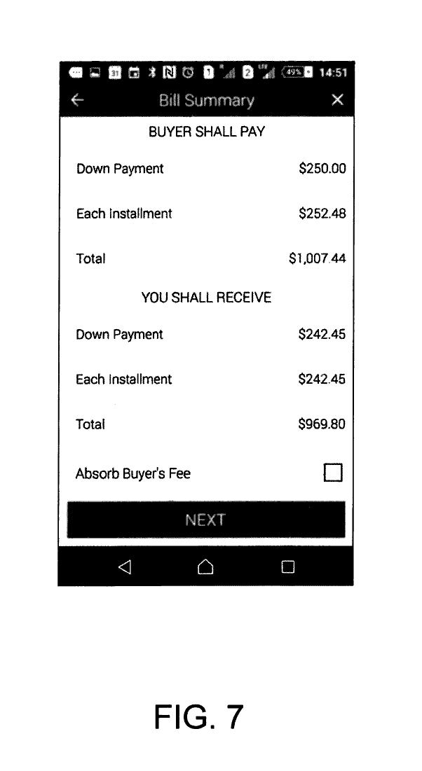

As for FIG. 4 to FIG. 8 show the detail operation how the seller create the installment data via previous app. First the seller should input the total price of the goods or services. Then, enters the down payment, and the app could provide multiple paying plans for the seller to choose from. If none of the paying plans meet the seller's need, the seller could also customize his own paying plan. After selecting or creating the paying plan, a paying plan (or summary) will be shown on the interface (FIG. 7) Then once the seller confirm, the details of the paying plan will be sent directly to the buyer. Or in some embodiment, the paying plan could be sent to the online platform, and the buyer could receive the information from the online platform.

The present invention is described as above with the foregoing preferred embodiments, but the embodiments are not intended to limit the present invention. Any person skilled in the art can make some variations and modifications without departing from the spirit and scope of the present invention. Therefore, the patent protection scope of the present invention should be subject to that defined by the claims appended to the specification.

What is claimed is:

1. A trading system with user-defined installments, comprising:
at least one first electrical device, for providing a commodity data and an installment data;
at least one second electrical device, for providing a buyer credit data and an order data; and
a server, receiving the commodity data and the installment data from the first electrical device and the buyer credit data from the second electrical device,
wherein the second electrical device transmits the buyer credit data and the order data to the server, then the server matches the order data of the second electrical device with the commodity data and the installment data from the first electrical device, a trading agreement will be transmitted to the first and second electrical devices.

2. The trading system according to claim 1, wherein the buyer credit data comprises address, email address, telephone number, social network account, identification card number, banking account number, income data, deposit card number, credit card number, debit card number, account number of third party payment service, credit score or credit rating.

3. The trading system according to claim 1, wherein the installment data comprises the number of payments, amount of the installment, down payment or service charge.

4. The trading system according to claim 1, wherein the trading agreement is a legal binding document.

5. The trading system according to claim 1, wherein the first electrical device transmits a credit rating request to the server, and the server compares the credit rating request with the buyer credit data.

6. The trading system according to claim 1, wherein the first electrical device transmits a seller credit data to the server.

7. The trading system according to claim 6, wherein the seller credit data comprises address, email address, telephone number, social network account, identification card number, banking account number, income data, credit score or credit rating.

8. The trading system according to claim 6, wherein the first electrical device encrypts the commodity data, the installment data and the seller credit data, and the second electrical device encrypts the seller credit data.

9. A trading method with user-defined installments, comprising:
the server receiving at least one commodity data and at least one installment data from the seller;
the server receiving at least one buyer credit data and at least one order data from the buyer;
the server matching the commodity data and the installment data from the seller with order data from the buyer; and
the server transmitting a trading agreement respectively to the seller and the buyer.

10. The trading method according to claim 9, further comprising;
the server verifying the buyer credit data that provided by the buyer.

11. The trading method according to claim 9, further comprising;
the seller transmitting the seller credit data to the server.

12. The trading method according to claim 9, wherein the server receives a credit rating request from the seller and the server compares the credit rating request with the buyer credit data.

13. The trading method according to claim 9, wherein a first electrical device encrypts the commodity data, the installment data and the seller credit data, and a second electrical device encrypts the seller credit data.

14. The trading method according to claim 9, wherein the trading agreement comprises a term while if any one of the installments is failed to pay or not fully paid after the due date, a third party will provide an installment load to cover up the installment in order to continue the trade.

15. A server connectable to a communication network for providing a service that provides a user-defined installments service, the server comprising:
an input for receiving at least one commodity data and at least one installment data from a first electrical device, and at least one buyer credit data and at least one order data from a second electrical device;
a matching unit, matching the commodity data and the installment data with order data; and
an output, transmitting a trading agreement respectively to the first electrical device and the second electrical device.

16. The server according to claim 15, further comprising;
a verifying unit, for verifying the buyer credit data.

17. The server according to claim 15, wherein the input receiving the seller credit data from the first electrical device.

18. The server according to claim 15, wherein the server receives a credit rating request from the first electrical device and the server compares the credit rating request with the buyer credit data.

19. The server according to claim 15, wherein a first electrical device encrypts the commodity data, the installment data and the seller credit data, and a second electrical device encrypts the seller credit data.

20. The server according to claim 15, wherein the trading agreement comprises a term while if any one of the installments is failed to pay or not fully paid after the due date, a third party will provide an installment load to cover up the installment in order to continue the trade.
